(19) United States
(12) Patent Application Publication
(10) Pub. No.: US 2024/0174571 A1
(43) Pub. Date: May 30, 2024

(54) GYPSUM BOARDS AND METHODS FOR MAKING THEM

(71) Applicant: CertainTeed Gypsum, Inc., Malvern, PA (US)

(72) Inventors: Dahlia Amato, Malvern, PA (US); Remi Lespiat, Devon, PA (US); Marion Grange, Malvern, PA (US)

(21) Appl. No.: 18/520,334

(22) Filed: Nov. 27, 2023

Related U.S. Application Data
(60) Provisional application No. 63/385,064, filed on Nov. 28, 2022.

(30) Foreign Application Priority Data
Jan. 23, 2023 (EP) 23152808.4

(51) Int. Cl. C04B 28/14; C04B 16/04; C04B 41/53

(52) U.S. Cl. CPC C04B 28/141; C04B 16/04; C04B 41/5307

(57) ABSTRACT

The present disclosure relates generally to a gypsum board comprising a gypsum core, the gypsum core comprising: a set body of calcium sulfate dihydrate; and a mixture of starches. The set gypsum core is made allowing a stucco slurry containing the starches to set. The mixture of feed starches comprises a first starch and a second starch, the first starch having a substantially lower peak viscosity than the second starch.

### CROSS-REFERENCE TO RELATED APPLICATIONS

This application claims the benefit of U.S. Provisional Patent Application No. 63/385,064, filed Nov. 28, 2022, and of European Patent Application no. 23152808.4, filed Jan. 23, 2023. each of which is hereby incorporated herein by reference in its entirety.

### FIELD

The present disclosure relates generally to gypsum boards and methods of making the same.

### TECHNICAL BACKGROUND

Gypsum building products (e.g., known variously as wallboard, ceiling board, plasterboard and “drywall”) are panels made of a gypsum core sandwiched between two layers of liner, often paper, on the outside surfaces of the gypsum core. They are widely used as construction materials due to their ease of fabrication, high mechanical strength, low thermal conductivity, resistance to spread of fire, and soundproofing properties. The quality of a gypsum board is strongly dependent on its gypsum core, which is fabricated by the hydration of stucco slurry (mainly containing calcium sulfate hemihydrate) into a set body of calcium sulfate dihydrate. To control the properties of gypsum boards, additives are often added to the stucco slurry during the board making process. For example, foaming agents, inorganic compounds, and other additives may be included in the slurry to modulate the density, strength, and/or fire resistance properties of the board.

To withstand handling, installation, and lifetime wear and tear, a gypsum board must have high core strength. As such, improving the core hardness of the gypsum board allows for more durable and dependable products. But it is also important to provide other desirable properties to a gypsum board, like good adhesion to a liner material (e.g., paper), and resistance to nail pull. To control the properties of gypsum boards, additives are often added to the stucco slurry during the board making process. For example, foaming agents, inorganic compounds, and other additives may be included in the slurry to modulate the density, strength, and/or fire resistance properties of the board. However, the inclusion of additives can alter the setting dynamics of the slurry which can influences the manufacturing process of the boards. As such, there is a need in the art for new strategies and additives to provide improved core hardness of gypsum boards without altering the manufacturing process.

### SUMMARY

In one aspect, the present disclosure provides a gypsum board comprising a gypsum core, the gypsum core comprising:
a set body of calcium sulfate dihydrate; and
a mixture of starches;
   wherein the set gypsum core is made by the method comprising:
providing a slurry comprising stucco, water, and a mixture of feed starches, the mixture having a peak viscosity in the range of 50 to 600 BU and/or 50 to 600 centipoise, the mixture of feed starches being present in an amount in the range of 0.05 wt % to 3 wt % of the weight of the stucco;
allowing the slurry to set to form a wet gypsum core; and
drying the wet gypsum core at a temperature in the range of 50-350° C. to provide a set gypsum core,
wherein the mixture of feed starches comprises a first starch and a second starch, the first starch having a substantially lower peak viscosity than the second starch.
   For example, in various embodiments, the first starch has a peak viscosity of at least 100 BU less than and/or at least 100 centipoise less than the peak viscosity of the second starch.

In various embodiments as otherwise described herein, the first starch is starch A and the second starch is starch B, wherein starch A is an acid-modified starch having a peak viscosity of no more than 200 BU and starch B is a chemically-modified starch having a peak viscosity of at least 800 BU. In various such embodiments, the weight ratio of starch A to starch B in the mixture of feed starches is no more than 90:10.

In various embodiments as otherwise described herein, the first starch is starch D and the second starch is starch C, wherein starch C is an acid-modified starch having a peak viscosity of at least 385 BU and starch D is an acid-modified starch having a peak viscosity of no more than 375 BU. In various such embodiments, the weight ratio of starch C to starch D in the mixture of feed starches is no more than 90:10. In various such embodiments, starch D is derived from a different crop source than a crop source of starch C.

In various embodiments as otherwise described herein, the first starch is starch E and the second starch is starch F, wherein starch F is an acid-modified starch having a peak viscosity of no more than 100 centipoise and starch F is an acid-modified starch having a peak viscosity at least 200 centipoise. In various such embodiments, the weight ratio of starch E to starch F in the mixture of feed starches is no more than 90:10.

In another aspect, the present disclosure provides for a method of forming a gypsum board (e.g., a board as described herein) comprising a gypsum core, the method comprising:
providing a slurry comprising stucco, water, and a mixture of feed starches, the mixture having a peak viscosity in the range of 50 to 600 BU, the mixture of feed starches being present in an amount in the range of 0.05 wt % to 3 wt % of the weight of the stucco,
allowing the slurry to set to form a wet gypsum core; and
drying the wet gypsum core at a temperature in the range of 50-350° C. to provide a set gypsum core,
wherein the mixture of feed starches comprises a first starch and a second starch, the first starch having a substantially lower peak viscosity than the second starch.
   For example, in various embodiments, the first starch has a peak viscosity of at least 100 BU less and/or at least 100 centipoise less than the peak viscosity of the second starch.

In various embodiments, the first starch is starch A and the second starch is starch B. In various embodiments, the first starch is starch D and the second starch is starch C. In various embodiments, the first starch is starch E, and the second starch is starch F.

### BRIEF DESCRIPTION OF THE DRAWINGS

FIG. 1 is a schematic cross-sectional view of a gypsum board of the disclosure.

FIG. 2 are viscoamylograms of mixtures of feed starches as described herein.

FIG. 3 is a bar graph of the core hardness of gypsum boards as described herein.

FIG. 4 one viscoamylograms of mixtures of feed starches as described herein.

FIG. 5 is a bar graph of the core hardness of gypsum boards as described herein.

FIG. 6 is a bar graph of nail pull results for gypsum boards as described herein.

### DETAILED DESCRIPTION

The present inventors have developed a gypsum board with an improved suite of properties and methods for making the same.

As described above, additives may be used to improve the core hardness of gypsum boards. However, the present inventors have noted that the inclusion of such additives often influences the setting mechanism and dynamics of the gypsum slurry, which may require changes to the overall manufacturing process of the board. Moreover, while core hardness is important, many other board properties are likewise important, including resistance to nail pull and resistance to delamination.

The present disclosure is concerned with providing a desirable suite of properties to gypsum boards with minimal changes to the overall production process of gypsum boards. To that end, the present inventors have found that by including a mixture of feed starches in the stucco slurry for making the gypsum board, and thus in the gypsum board itself, good overall properties can be achieved. Further, the present inventors have found that inclusion of such starches do not require changes to the manufacturing process. According, the present inventors have advantageously found gypsum board formulations that provides a good suite of properties without requiring changes to the manufacturing process.

In one aspect, the present disclosure provides for a gypsum board comprising a gypsum core comprising a set body of calcium sulfate dihydrate; and a mixture of starches. In some embodiments as described herein, the set gypsum core is made by a method including providing a slurry comprising stucco, water, and a mixture of feed starches, the mixture having a peak viscosity in the range of 50 to 600 BU and/or in the range of 50-600 centipoise, the mixture of feed starches being present in an amount in the range of 0.05 wt % to 3 wt % of the weight of the stucco; allowing the slurry to set to form a wet gypsum core; and drying the wet gypsum core at a temperature in the range of 50-350° C. to provide a set gypsum core. The mixture of feed starches comprises a first starch and a second starch, the first starch having a substantially lower peak viscosity than the second starch. The present inventors have determined that using a mixture of starches of different peak viscosities can provide desirable combinations of properties in gypsum building boards. As the person of ordinary skill in the art will appreciate, the mixture of feed starches can be provided to the starch slurry as a mixture, or rather can be provided individually to the slurry and mixed together therein.

For example, in various embodiments, the first starch has a peak viscosity of at least 50 BU less than the peak viscosity of the second starch. In various embodiments, the first starch has a peak viscosity of at least 75 BU less than the peak viscosity of the second starch. In various embodiments, the first starch has a peak viscosity of at least 100 BU less than the peak viscosity of the second starch. In various embodiments, the first starch has a peak viscosity of at least 120 BU less than the peak viscosity of the second starch. In various embodiments, the first starch has a peak viscosity of at least 150 BU less than the peak viscosity of the second starch. In various embodiments, the first starch has a peak viscosity of at least 200 BU less than the peak viscosity of the second starch. In various embodiments, the first starch has a peak viscosity of at least 350 BU less than the peak viscosity of the second starch. In various embodiments, the first starch has a peak viscosity of at least 500 BU less than the peak viscosity of the second starch.

Similarly, in various embodiments, the first starch has a peak viscosity of at least 50 centipoise less than the peak viscosity of the second starch. In various embodiments, the first starch has a peak viscosity of at least 75 centipoise less than the peak viscosity of the second starch. In various embodiments, the first starch has a peak viscosity of at least 100 centipoise less than the peak viscosity of the second starch. In various embodiments, the first starch has a peak viscosity of at least 120 centipoise less than the peak viscosity of the second starch. In various embodiments, the first starch has a peak viscosity of at least 150 centipoise less than the peak viscosity of the second starch. In various embodiments, the first starch has a peak viscosity of at least 200 centipoise less than the peak viscosity of the second starch. In various embodiments, the first starch has a peak viscosity of at least 350 BU less than the peak viscosity of the second starch. In various embodiments, the first starch has a peak viscosity of at least 500 centipoise less than the peak viscosity of the second starch.

The present inventors have determined that it is desirable for the overall mixture of the feed starches to have a peak viscosity in the range of 50-600 BU and/or 50-600 centipoise. For example, in various embodiments, the mixture of the feed starches has a peak viscosity in the range of 50-600 BU, e.g., 50-550 BU, or 50-500 BU, or 50-450 BU, or 50-400 BU. In various embodiments, the mixture of the feed starches has a peak viscosity in the range of 100-600 BU, e.g., 100-550 BU, or 100-500 BU, or 100-450 BU, or 100-400 BU. In various embodiments, the mixture of the feed starches has a peak viscosity in the range of 150-600 BU, e.g., 150-550 BU, or 150-500 BU, or 150-450 BU, or 150-400 BU. In various embodiments, the mixture of the feed starches has a peak viscosity in the range of 50-600 centipoise, e.g., 50-550 centipoise, or 50-500 centipoise, or 50-450 centipoise, or 50-400 centipoise. In various embodiments, the mixture of the feed starches has a peak viscosity in the range of 100-600 centipoise, e.g., 100-550 centipoise, or 100-500 centipoise, or 100-450 centipoise, or 100-400 centipoise. In various embodiments, the mixture of the feed starches has a peak viscosity in the range of 150-600 centipoise, e.g., 150-550 centipoise, or 150-500 centipoise, or 150-450 centipoise, or 150-400 centipoise.

As used herein, peak viscosity of a starch sample (be it a single starch or a combination of starches) in Brabender units (BU) is measured by measuring a slurry of the starch sample in water at a concentration of 15% solids with a Viscograph-E instrument set to 75 rpm and 700 cmg, where the slurry is held at 25 C for 5 minutes; heated from 25° C. to 95° C. at a rate of 3° C./minute; held at 95° C. for 10 minutes; and cooled to 50° C. at a rate of 3° C./minute. The peak viscosity is determined as the maximum viscosity of the starch slurry measured by the above method with a Brabender Viscometer.

As used herein, the peak viscosity of a starch sample (be it a single starch or a combination of starches) in units of centipoise is measured using a Discovery Hybrid Rheometer (DHR) operating at a constant shear rate of 26.2 s⁻¹. A 15% by weight suspension of the starch sample in deionized water is loaded into the DHR using the starch cup and blade. The starch suspension is subjected to a temperature profile: Hold at 25° C. for 5 min; Heat from 25° C. to 95° C. at 3° C./min; Hold at 95° C. for 10 min; Cool from 95° C. to 50° C. at −3° C./min. The peak viscosity is determined as the maximum viscosity of the starch slurry measured by the DHR during the temperature profile.

The present inventors have also noted that it can be desirable for the first starch to have a gel temperature that is substantially higher than a gel temperature of the second starch. For example, in various embodiments, the first starch has a gel temperature at least 5° C. higher than a gel temperature of the second starch, e.g., at least 7° C. higher, or at least 10° C. higher. In various embodiments, the first starch has a gel temperature in the range of 5-20° C. higher than a gel temperature of the second starch, e.g., in the range of 7-20° C. higher, or 10-20° C. higher, or 5-17° C. higher, or 7-17° C. higher, or 10-17° C. higher, or 5-15° C. higher, or 7-15° C. higher, or 10-15° C. higher, or 5-12° C. higher, or 7-12° C. higher, or 5-10° C. higher. Gel temperature as used herein is the onset temperature for the inflection in rise in viscosity to the peak viscosity, as measured by the measurement provided for BU.

In various methods for making the boards described herein, the mixture of feed starches are included in a slurry that includes stucco and water; the slurry is allowed to set to ultimately form the gypsum core, as described in more detail below. The mixture of feed starches has properties that can be modified by selection of a combination of starches based on the disclosure herein.

In various embodiments, the first and second starches are not pregelatinized. As would be understood by the skilled person, a pregelatinized starched (or a cooked starch) are often prepared by heating and extruding a slurry of starch. In doing so, the crystalline structure of the starch granules rupture, resulting in starches with lower gelatinization temperatures as compared to uncooked starches. Uncooked starches are not modified by heat or extrusion and retain the crystalline structure of the starch granules. Pregelatinized starches tend to thicken in cold water, while uncooked starches generally will not. Use of an uncooked modified starch in the slurry can allow for desirable processing. As such, in some embodiments as described herein, the mixture of feed starches has a gel temperature of at least 50° C. In some embodiments as described herein, the mixture of feed starches has a gel temperature of no more than 100° C. For example, in various embodiments, the mixture of feed starches has a gel temperature of no more than 95° C., or 90° C., or 85° C., or 80° C., or 75° C., or 72° C. In various embodiments as described herein, the mixture of feed starches has a gel temperature in the range of 60-100° C., or 60-95° C., or 60-90° C., or 60-85° C., or 60-80° C., or 60-75° C., or 60-72° C., or 65-100° C., or 65-95° C., or 60-90° C., or 60-85° C., or 65-80° C., or 65-75° C., or 65-72° C.

In some embodiments as described herein, each of the first and second starch has a gel temperature of at least 50° C. In some embodiments as described herein, each of the first and second starch has a gel temperature of no more than 100° C. For example, in various embodiments, each of the first and second starch has a gel temperature of no more than 95° C., or 90° C., or 85° C., or 80° C., or 75° C. In various embodiments as described herein, each of the first and second starch has a gel temperature in the range of 60-90° C., of 60-85° C., or 60-80° C., or 60-75° C., or 60-90° C., or 60-85° C., or 65-80° C., or 65-75° C.

A variety of types of starches can be used, from a variety of crop sources, e.g., a corn starch, a wheat starch, a tapioca starch, a potato starch, a pea starch, a sorghum starch, or a rice starch.

In various embodiments, the first starch is an acid-modified starch. Acid modification is a well-known technique that can be used to reduce the viscosity of starch. Acid modification can be used to provide starches of a variety of lowered viscosities as compared to a native, non-acid-modified starch. In many embodiments, it is desirable for the first starch to have minimal, if any, further modifications. For example, in various embodiments, the first starch is not crosslinked and is not modified by substitution.

Similarly, in various embodiments, the second starch is an acid-modified starch. Here, too, acid modification can be used to lower the viscosity of the starch, but to a substantially higher peak viscosity than the first starch. However, in other embodiments, the second starch is not an acid-modified starch.

It can be desirable in some embodiments for the second starch is modified by substitution, e.g., by hydroxyalkylation (e.g., hydroxyethylation, hydroxypropylation, hydroxybutylation); acylation (e.g., acetylation); carboxymethylation; alkylation (e.g., ethylation, butylation, or propylation); or succination.

The present inventors have found that it can be desirable to use a substantial amount of each of the first and second starches. For example, in various embodiments, a weight ratio of the first starch to the second starch is in the range of 10:90-90:10, e.g., 10:90-50:50, or 10:90-30:70, or 50:50-90:10, or 70:30-90:10. In various embodiments, a weight ratio of the first starch to the second starch is in the range of 20:80-80:20, e.g., 20:80-50:50, or 20:80-40:60, or 50:50-80:20, or 60:40-80:20. In various a weight ratio of the first starch to the second starch is in the range of 30:70-70:30, e.g., 30:70-50:50, or 50:50-30:70. In various embodiments, a weight ratio of the first starch to the second starch is in the range of 40:60-60:40.

The person of ordinary skill in the art will, based on the present disclosure, provide first and second starches in appropriate amounts to provide desirable combinations of properties, e.g., of core hardness, nail pull and liner bond strength.

In some embodiments as described herein, the mixture of feed starches is a mixture of starch A as the first starch and starch B as the second starch. As described above, starch A is an acid-modified low-viscosity starch, while starch B is a chemically modified high-viscosity starch. As used herein, a low-viscosity starch has a peak viscosity of no more than 200 BU, while a high viscosity starch has a peak viscosity of greater than 800 BU. The present inventors have noted in the Examples below that gypsum boards made with this combination of starches provides boards with a desirable suite of properties, including good core hardness.

As described above, starch A has a peak viscosity of no more than 200 BU. In various embodiments, starch A has a peak viscosity of no more than 175 BU, no more than 150 BU, no more than 125 BU, or no more than 100 BU, or no more than 75 BU. In some embodiments, starch A has a peak viscosity in the range of 30-200 BU. For example, in various embodiments, starch A has a peak viscosity in the range of 30-175 BU, or 30-150 BU, or 30-125 BU, or 30-100 BU, or 60-200 BU, or 60-175 BU, or 60-150 BU, or 60-125 BU, or 60-100 BU.

As described above, starch A is an acid-modified starch; the person of ordinary skill in the art will appreciate that acid-modification can be used to provide the starch with a desired viscosity, with a greater degree of acid-modification providing a lower viscosity. In some embodiments as described herein, starch A is acid-modified but is otherwise unmodified. For example, in various embodiments starch A is not further functionalized by hydroxyalkylation (e.g., hydroxyethylation, hydroxypropylation, hydroxybutylation); acylation (e.g., acetylation); carboxymethylation; alkylation (e.g., ethylation, butylation, or propylation); succination; or oxidation. In some embodiments as described herein, starch A is not inhibited. For example, in various embodiments, starch A is not cross-linked (e.g., by phosphate).

As the person of ordinary skill in the art will appreciate, a number of starches can be suitable for use as starch A in the materials and processes described herein. The source of starch A is not particularly limited. For example, starch A may be a corn starch, a wheat starch, a tapioca starch, a potato starch, a pea starch, a sorghum starch, or a rice starch. In various embodiments, starch A may be a wheat starch, a tapioca starch, or a corn starch. In some embodiments of the disclosure as otherwise described herein, starch A is a corn starch. In various embodiments, starch A is a dent corn starch.

In some embodiments as described herein, starch A is not pregelatinized. As such, in some embodiments as described herein, starch A has a gel temperature of at least 50° C. In some embodiments as described herein, starch A has a gel temperature of no more than 100° C. For example, in various embodiments, starch A has a gel temperature of no more than 95° C., or no more than 90° C., or no more than 85° C., or no more than 80° C., or no more than 75° C. In various embodiments as described herein, starch A has a gel temperature in the range of 60-90° C., of 60-85° C., or 60-80° C., or 60-75° C., or 60-90° C., or 60-85° C., or 65-80° C., or 65-75° C.

Many starches suitable for use in gypsum products are commercially available; the person of ordinary skill in the art can, based on the present disclosure, select ones that have appropriate viscosities for a desired product. For example, in some embodiments as described herein, starch A is Supercore® S23F from GPC.

As such, the present inventors have found it advantageous that, in contrast to starch A, starch B is a chemically modified high-viscosity starch. As such, in various embodiments, starch B has a peak viscosity of at least 800 BU, e.g., at least 900 BU, at least 950 BU, or at least 1000 BU, or at least 1050 BU, or at least 1100 BU, or at least 1150 BU. In some embodiments, starch B has a peak viscosity in the range of 800-1400 BU. For example, in various embodiments, starch B has a peak viscosity in the range of 800-1300 BU, or 800-1200 BU, or 900-1400 BU, or 900-1300-BU, or 900-1200 BU, or 1000-1400 BU, or 1000-1300 BU, or 1000-1200 BU.

As described above, starch B is a chemically-modified starch; the person of ordinary skill in the art will appreciate that chemical modification can be used to provide the starch with a desired high viscosity. Additionally, the skilled person would understand that a chemical modification is different than an acid-modification, like that of starch A. In some embodiments as described herein, the modification of starch B is a hydroxyalkylation (e.g., hydroxyethylation, hydroxypropylation, hydroxybutylation); acylation (e.g., acetylation); carboxymethylation; alkylation (e.g., ethylation, butylation, or propylation); succination; or oxidation. In some embodiments as described herein, the modification of starch B is hydroxyethylation. In some embodiments as described herein, starch B is hydroxyalkylated (e.g., hydroxyethylated) but otherwise unmodified.

In some embodiments, starch B is not inhibited. For example, in some embodiments, starch B is not cross-linked (e.g., by phosphate).

As the person of ordinary skill in the art will appreciate, a number of starches and a number of modifications can be suitable for use as starch B in the materials and processes described herein. The source of starch B is not particularly limited. For example, starch B may be a corn starch, a wheat starch, a tapioca starch, a potato starch, a pea starch, a sorghum starch, or a rice starch. In various embodiments, starch B may be a wheat starch, a tapioca starch, or a corn starch. In some embodiments of the disclosure as otherwise described herein, starch B is a corn starch, e.g., a dent corn starch. In various embodiments, starch B is a dent corn starch.

In some embodiments as described herein, starch B is not pregelatinized (i.e., is an uncooked starch). Use of an uncooked modified starch in the slurry can allow for desirable processing. In some embodiments as described herein, starch B has a gel temperature of at least 50° C. In some embodiments as described herein, starch B has a gel temperature of no more than 100° C. For example, in various embodiments, starch B has a gel temperature of no more than 95° C., or no more than 90° C., or no more than 85° C., or no more than 80° C., or no more than 75° C., or no more than 70° C., or no more than 65° C. In various embodiments as described herein, starch B has a gel temperature in the range of 50-80° C., or 50-75° C., or 50-70° C., or 50-65° C., or 55-80° C., or 55-75° C., or 55-70° C., or 55-65° C. In some embodiments of the disclosure as described herein, the gel temperature of starch A is greater than the gel temperature of starch B. The present inventors have found that when the gel temperature of starch A is greater than the gel temperature of starch B, the gel temperature of the mixture of feed starches can advantageously be modified to provide a desired gel temperature of the mixture of starches.

Many starches suitable for use in gypsum products are commercially available; the person of ordinary skill in the art can, based on the present disclosure, select ones that have appropriate viscosities for a desired product. For example, in some embodiments, starch B is Ethylex® 2075 from Primient.

As described above, mixture of feed starches can include a combination of starch A and starch B. In some embodiments as described herein, the weight ratio of starch A to starch B in the mixture of feed starches is no more than 90:10. In various embodiments as described herein, the weight ratio of starch A to starch B in the mixture of feed starches is no more than 85:15, no more than 80:20, no more than 75:25, or no more than 70:30. In some embodiments, the weight ratio of starch A to starch B in the mixture of feed starches is in the range of 50:50 to 90:10. For example, in various embodiments, the weight ratio of starch A to starch B is in the range of 50:50 to 80:20, or 50:50 to 70:30, or 60:40 to 90:10, or 60:40 to 80:20, or 60:40 to 70:30.

In some embodiments as described herein, the mixture of feed starches is a combination of starch C and starch D, wherein starch C is an acid-modified starch having a peak viscosity of at least 385 BU and starch D is an acid-modified starch having a peak viscosity of no more than 375 BU.

As described above, starch C is an acid-modified starch, while starch D is an acid-modified starch, where starch D has a lower peak viscosity then starch C. In various embodiments, both starch C and starch D are medium viscosity starches. As used herein, a medium viscosity starch has a peak viscosity in the range of about 100 BU to about 800 BU. As described herein, starch C has a peak viscosity of at least 385 BU. For example, in various embodiments, starch C has a peak viscosity of at least 400 BU or at least 425 BU. In some embodiments, starch C has a peak viscosity in the range of 385-800 BU. For example, in various embodiments, starch C has a peak viscosity in the range of 385-700 BU, or 385-600 BU, or 385-500 BU, or 400-800 BU, or 400-700 BU, or 400-600 BU, or 400-500 BU, or 425-800 BU, or 425-700 BU, or 425-600 BU, or 425-500 BU.

As described above, starch C is an acid-modified starch; the person of ordinary skill in the art will appreciate that acid-modification can be used to provide the starch with a desired viscosity, with a greater degree of acid modification providing a lower viscosity. In some embodiments as described herein, starch C is acid-modified but is otherwise unmodified. For example, starch C is not further functionalized by hydroxyalkylation (e.g., hydroxyethylation, hydroxypropylation, hydroxybutylation); acylation (e.g., acetylation); carboxymethylation; alkylation (e.g., ethylation, butylation, or propylation); succination; or oxidation.

In some embodiments as described herein, starch C is not inhibited. For example, starch C is not cross-linked (e.g., by phosphate).

As the person of ordinary skill in the art will appreciate, a number of starches can be suitable for use as starch C in the materials and processes described herein. The source of starch C is not particularly limited. For example, starch C may be a corn starch, a wheat starch, a tapioca starch, a potato starch, a pea starch, a sorghum starch or a rice starch. In various embodiments, starch C may be a wheat starch, a tapioca starch, or a corn starch. In some embodiments of the disclosure as otherwise described herein, starch C is a corn starch. In various embodiments, starch C is a dent corn starch.

In some embodiments as described herein, starch C is not pregelatinized (i.e., is an uncooked starch). Use of an uncooked modified starch in the slurry can allow for desirable processing. As such, in some embodiments as described herein, starch C has a gel temperature of at least 50° C. In some embodiments as described herein, starch C has a gel temperature of no more than 100° C. For example, in various embodiments, starch C has a gel temperature of no more than 95° C., or no more than 90° C., or no more than 85° C., or no more than 80° C., or no more than 75° C. In various embodiments as described herein, starch C has a gel temperature in the range of 60-90° C., of 60-85° C., or 60-80° C., or 60-75° C., or 60-90° C., or 60-85° C., or 65-80° C., or 65-75° C.

Many starches suitable for use in gypsum products are commercially available; the person of ordinary skill in the art can, based on the present disclosure, select ones that have appropriate viscosities for a desired product. For example, in some embodiments as described herein, starch C is Caliber 150 from Cargill.

As described above, in some embodiments, the mixture of feed starches includes a combination (e.g., a mixture) of starch C and starch D. The present inventors have found that by using a combination of starch C and starch D, the properties of the mixture of feed starches can be modulated based on the properties of starch C and starch D. As such, the present inventors have found it advantageous that both starch C and starch D are acid-modified starches, but with starch D having a lower peak viscosity than starch C. As such, in some embodiments, starch D has a peak viscosity of no more than 375 BU. For example, in some embodiments, starch D has a peak viscosity of no more than 350 BU. In some embodiments, starch D has a peak viscosity in the range of 150-375 BU. For example, in various embodiments, starch D has a peak viscosity in the range of 200-375 BU, or 250-375 BU, or 300-375 BU, or 150-350 BU, or 200-350 BU, or 250-350 BU, or 300-350 BU.

As described above, starch D is an acid-modified starch; the person of ordinary skill in the art will appreciate that acid modification can be used to provide the starch with a desired viscosity, with a greater degree of acid modification providing a lower viscosity. In some embodiments as described herein, starch D is acid-modified but is otherwise unmodified. For example, starch D is not further functionalized by hydroxyalkylation (e.g., hydroxyethylation, hydroxypropylation, hydroxybutylation); acylation (e.g., acetylation); carboxymethylation; alkylation (e.g., ethylation, butylation, or propylation); succination; or oxidation.

In some embodiments as described herein, starch D is not inhibited. For example, starch D is not cross-linked (e.g., by phosphate).

As the person of ordinary skill in the art will appreciate, a number of starches can be suitable for use as starch D in the materials and processes described herein. The source of starch D is not particularly limited. For example, starch D may be a corn starch, a wheat starch, a tapioca starch, a potato starch, a pea starch, a sorghum starch or a rice starch. In various embodiments, starch D may be a wheat starch, a tapioca starch, or a corn starch. In some embodiments of the disclosure as otherwise described herein, starch D is a wheat starch. In various embodiments, starch D is a dent corn starch.

In various embodiments, starch D is derived from a different crop source than a crop source of starch C. In some embodiments as described herein, starch D is a wheat starch and starch C is a corn starch.

In some embodiments as described herein, starch D is not pregelatinized (i.e., is an uncooked starch). Use of an uncooked modified starch in the slurry can allow for desirable processing. In some embodiments as described herein, starch D has a gel temperature of at least 50° C. In some embodiments as described herein, starch D has a gel temperature of no more than 100° C. For example, in various embodiments, starch D has a gel temperature of no more than 95° C., or no more than 90° C., or no more than 85° C., or no more than 80° C., or no more than 75° C., or no more than 70° C., or no more than 65° C. In various embodiments as described herein, starch D has a gel temperature in the range of 50-80° C., or 50-75° C., or 50-70° C., or 50-65° C., or 55-80° C., or 55-75° C., or 55-70° C., or 55-65° C. In some embodiments of the disclosure as described herein, the gel temperature of starch C is greater than the gel temperature of starch D.

Many starches suitable for use in gypsum products are commercially available; the person of ordinary skill in the art can, based on the present disclosure, select ones that have appropriate viscosities for a desired product. For example, in some embodiments as described herein, starch D is Corebind from ADM.

As described above, in some embodiments, mixture of feed starches can include a combination of starch C and starch D. In some embodiments as described herein, the weight ratio of starch C to starch D in the mixture of feed starches is no more than 90:10. In various embodiments as described herein, the weight ratio of starch C to starch D in the mixture of feed starches is no more than 85:15, no more than 80:20, no more than 75:25, or no more than 70:30. In some embodiments, the weight ratio of starch C to starch D in the mixture of feed starches is in the range of 50:50 to 90:10. For example, in various embodiments, the weight ratio of starch C to starch D is in the range of 50:50 to 80:20, or 50:50 to 70:30, or 60:40 to 90:10, or 60:40 to 80:20, or 60:40 to 70:30.

In various embodiments of the disclosure, the mixture of starches is a combination of starch E and starch F, wherein starch E is an acid-modified starch having a peak viscosity of no more than 100 centipoise and starch F is an acid-modified starch having a peak viscosity at least 200 centipoise.

As described above, starch E is an acid-modified starch having a peak viscosity of no more than 100 centipoise. For example, in various embodiments, starch E has a peak viscosity of no more than 80 centipoise, e.g., no more than 60 centipoise. In some embodiments, starch E has a peak viscosity in the range of 20-100 BU. For example, in various embodiments, starch E has a peak viscosity in the range of 30-100 centipoise, or 35-100 centipoise, or 40-100 centipoise, or 20-80 centipoise, or 30-80 centipoise, or 35-80 centipoise, or 40-80 centipoise, or 20-60 centipoise, or 30-60 centipoise, or 35-60 centipoise, or 40-60 centipoise.

As described above, starch E is an acid-modified starch; the person of ordinary skill in the art will appreciate that acid-modification can be used to provide the starch with a desired viscosity, with a greater degree of acid modification providing a lower viscosity. In some embodiments as described herein, starch E is acid-modified but is otherwise unmodified. For example, in various embodiments starch E is not further functionalized by hydroxyalkylation (e.g., hydroxyethylation, hydroxypropylation, hydroxybutylation); acylation (e.g., acetylation); carboxymethylation; alkylation (e.g., ethylation, butylation, or propylation); succination; or oxidation.

In some embodiments as described herein, starch E is not inhibited. For example, starch E is not cross-linked (e.g., by phosphate).

As the person of ordinary skill in the art will appreciate, a number of starches can be suitable for use as starch E in the materials and processes described herein. The source of starch E is not particularly limited. For example, starch E may be a corn starch, a wheat starch, a tapioca starch, a potato starch, a pea starch, a sorghum starch or a rice starch. In some embodiments of the disclosure as otherwise described herein, starch E is a sorghum starch.

In some embodiments as described herein, starch E is not pregelatinized (i.e., is an uncooked starch). Use of an uncooked modified starch in the slurry can allow for desirable processing. As such, in some embodiments as described herein, starch E has a gel temperature of at least 50° C. In some embodiments as described herein, starch E has a gel temperature of no more than 100° C. For example, in various embodiments, starch E has a gel temperature of no more than 95° C., or no more than 90° C., or no more than 85° C., or no more than 80° C., or no more than 75° C. In various embodiments as described herein, starch E has a gel temperature in the range of 60-90° C., of 60-85° C., or 60-80° C., or 60-75° C., or 60-90° C., or 60-85° C., or 65-80° C., or 65-75° C.

Many starches suitable for use in gypsum products are commercially available; the person of ordinary skill in the art can, based on the present disclosure, select ones that have appropriate viscosities for a desired product. For example, in some embodiments as described herein, starch E is LC-211 from ADM.

As described above, starch F is an acid-modified starch having a peak viscosity of at least 200 centipoise. For example, in various embodiments, starch F has a peak viscosity of at least 250 centipoise, e.g., at least 300 centipoise. In various embodiments, starch F has a peak viscosity in the range of 200-600 centipoise, e.g., in the range of 200-500 centipoise, or 200-400 centipoise, or 250-600 centipoise, or 250-500 centipoise, or 250-400 centipoise, or 300-600 centipoise, or 300-500 centipoise, or 300-400 centipoise.

As described above, starch F is an acid-modified starch; the person of ordinary skill in the art will appreciate that acid modification can be used to provide the starch with a desired viscosity, with a greater degree of acid modification providing a lower viscosity. In some embodiments as described herein, starch F is acid-modified but is otherwise unmodified. For example, starch F is not further functionalized by hydroxyalkylation (e.g., hydroxyethylation, hydroxypropylation, hydroxybutylation); acylation (e.g., acetylation); carboxymethylation; alkylation (e.g., ethylation, butylation, or propylation); succination; or oxidation.

In some embodiments as described herein, starch F is not inhibited. For example, starch F is not cross-linked (e.g., by phosphate).

As the person of ordinary skill in the art will appreciate, a number of starches can be suitable for use as starch F in the materials and processes described herein. The source of starch F is not particularly limited. For example, starch F may be a corn starch, a wheat starch, a tapioca starch, a potato starch, a pea starch, a sorghum starch or a rice starch. In some embodiments of the disclosure as otherwise described herein, starch F is a sorghum starch.

In some embodiments as described herein, starch F is not pregelatinized (i.e., is an uncooked starch). Use of an uncooked modified starch in the slurry can allow for desirable processing. In some embodiments as described herein, starch F has a gel temperature of at least 50° C. In some embodiments as described herein, starch F has a gel temperature of no more than 100° C. For example, in various embodiments, starch F has a gel temperature of no more than 95° C., or no more than 90° C., or no more than 85° C., or no more than 80° C., or no more than 75° C., or no more than 70° C., or no more than 65° C. In various embodiments as described herein, starch F has a gel temperature in the range of 50-80° C., or 50-75° C., or 50-70° C., or 50-65° C., or 55-80° C., or 55-75° C., or 55-70° C., or 55-65° C. In some embodiments of the disclosure as described herein, the gel temperature of starch E is greater than the gel temperature of starch F.

Many starches suitable for use in gypsum products are commercially available; the person of ordinary skill in the art can, based on the present disclosure, select ones that have appropriate viscosities for a desired product. For example, in some embodiments as described herein, starch F is LC-295 from ADM.

As described above, in some embodiments, mixture of feed starches can include a combination of starch E and starch F. In some embodiments as described herein, the weight ratio of starch E to starch F in the mixture of feed starches is no more than 90:10. In various embodiments as described herein, the weight ratio of starch E to starch F in the mixture of feed starches is no more than 85:15, no more than 80:20, no more than 75:25, or no more than 70:30. In some embodiments, the weight ratio of starch E to starch F in the mixture of feed starches is in the range of 10:90-90:10, e.g., 20:80-80:20. For example, in various embodiments, the weight ratio of starch E to starch F is in the range of 30:70-70:30, e.g., in the range of 30:70-60:40, or 30:70-50:50, or 40:60-70:30, or 40:60-60:40, or 50:50-70:30.

As described above, in various embodiments, the gypsum core includes a mixture of starches, in an amount in the range of 0.05-3 wt % of the stucco used to make the slurry used to make the gypsum core. In various embodiments as otherwise described herein, the mixture of starches is present in an amount in the range of 0.05-2.5 wt %, or 0.05-2 wt %, or 0.05-1.5 wt % of the stucco used to make the slurry used to make the gypsum core. In various embodiments as otherwise described herein, the mixture of starches is present in an amount in the range of 0.1-3 wt %, e.g., 0.1-2.5 wt %, or 0.1-2 wt %, or 0.1-1.5 wt % of the stucco used to make the slurry used to make the gypsum core. In various embodiments as otherwise described herein, the mixture of starches is present in an amount in the range of 0.5-3 wt %, e.g., 0.5-2.5 wt %, or 0.5-2 wt %, or 0.5-1.5 wt % of the stucco used to make the slurry used to make the gypsum core. In various embodiments as otherwise described herein, the mixture of starches is present in an amount in the range of 0.75-3 wt %, e.g., 0.75-2.5 wt %, or 0.75-2 wt %, or 0.75-1.5 wt % of the stucco used to make the slurry used to make the gypsum core. In various embodiments as otherwise described herein, the mixture of starches is present in an amount in the range of 1-3 wt %, e.g., 1-2.5 wt %, or 1-2 wt %, or 1-1.5 wt % of the stucco used to make the slurry used to make the gypsum core. The person of ordinary skill in the art will, based on the present disclosure, determine an appropriate amount of the starch to provide the desired water resistance, and other desirable board properties.

In some embodiments of the disclosure as described herein, the starch concentration in the center of the gypsum core is at least 50% of the concentration within 10% of an outer edge of the gypsum core. For example, in various embodiments, the starch concentration in the center of the gypsum core is at least 60%, or at least 65%, or at least 70%, or at least 75%, of the concentration within 10% of an outer edge of the gypsum core. In some embodiments, the starch concentration in the center of the gypsum core is at least 50% of the concentration at the edge of the gypsum core. In various embodiments, the starch concentration in the center of the gypsum core is at least 60%, or at least 65%, or at least 70%, or at least 75% of the concentration at the outer edge of the gypsum core. “Center” and “outer edge” in this regard refers to sites measured along the thickness axis of the board.

In various embodiments, the gypsum core includes a mixture of starches present in an amount in the range of 0.05-3 wt % based on the amount of stucco used to make the slurry that sets to make the core. As would be understood by the skilled person, this amount is an average amount over the volume of the core, and that the concentration of the starch may be different throughout layers of the core. However, as hypothesized by the present inventors, the starch concentration will depend on relative amounts of high-viscosity and low-viscosity starches, with low-viscosity starches migrating preferentially to the faces of the core, and the high-viscosity starches remaining relatively evenly-dispersed throughout the core.

The present disclosure relates to gypsum boards with improved core hardness. In various embodiments, the gypsum board of the present disclosure has a normalized core hardness of at least 60 N. For example, in various embodiments as described herein, the gypsum board as described herein has a normalized core hardness of at least 65 N, at least 70 N, or at least 75 N. Core hardness is measured with respect to ASTM C473. Values are normalized with respect to a density corresponding to 1500 lbs/msf at ½″ thickness

The size and shape (e.g., length, width, and thickness) of the gypsum board is not particularly limited, and the person of ordinary skill in the art would be able to choose an appropriate shape and size for the desired application. In some embodiments of the disclosure as otherwise described herein, the gypsum board has a density of at least 25 lbs/ft³ or at least 30 lbs/ft³, normalized to ½″ thickness. In some embodiments, the gypsum board has a density in the range of 20-80 lbs/ft³. For example, in various embodiments of the disclosure as described herein, the gypsum board has a density in the range of 20-70 lbs/ft³, or 20-60 lbs/ft³, or 25-80 lbs/ft³, or 25-70 lbs/ft³, or 25-60 lbs/ft³, or 30-80 lbs/ft³, or 30-70 lbs/ft³, or 30-60 lbs/ft³.

As is conventional, a variety of other components may be present in the gypsum core. For example, one or more accelerators, fluidizers, retarders, dispersants, foaming agents, and/or glass fibers maybe be present in the gypsum core. Such components may be present in a variety of amounts. For examples, the components may be present in an about of no more than 5 wt %, e.g., no more than 3 wt %, or no more than 2 wt %. Desirably, the gypsum core is at least 75 wt % gypsum, e.g., at least 80 wt % gypsum, or at least 85 wt % gypsum.

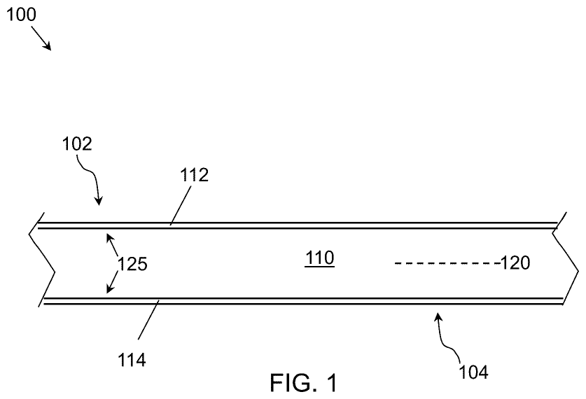

As the person of ordinary skill in the art will appreciate, gypsum boards are typically provided with liners at opposing major surfaces thereof. An example of such a gypsum board is shown in a cross-sectional schematic view in FIG. 1. Here, gypsum board 100 having opposing major surfaces 102 and 104 includes a gypsum core 110 disposed between liner 112 (at major surface 102) and liner 114 (at major surface 104). The liners can be formed, for example, from paper (which itself can be coated with a variety of substances, e.g., wax or silicone) or fiberglass. Of course, other liner materials are possible.

Another aspect of the present disclosure provides for a method of forming a gypsum board having a gypsum core. The method includes providing a slurry comprising stucco, water, and a mixture of feed starches, the mixture having a peak viscosity in the range of 50 to 600 BU, the mixture of feed starches being present in an amount in the range of 0.05-3 wt % (or some other amount as described above) of the weight of the stucco. The mixture of feeds starches can be any mixture of starches as described herein. With the selection of the mixture of feed starches as described herein, the person of ordinary skill in the art can use conventional processes for making the gypsum boards as described herein. The various parameters as described above with respect to the boards can be used in the methods described herein.

As is known in the art, stucco can have a variety of compositions depending on the source and application at hand. As used herein, a “stucco” is a material having at least 75 wt % of calcium sulfate hemihydrate. It is typically provided by calcining gypsum to convert the dihydrate of gypsum to hemihydrate. Real-world samples of stucco typically include, together with the hemihydrate (e.g., present as α-calcium sulfate hemihydrate, β-calcium sulfate hemihydrate, or combinations thereof), one or more of calcium sulfate dihydrate, calcium sulfate anhydrate, and inert calcium sulfate.

As described above, the method of the present disclosure includes providing a slurry that comprises stucco and water. As the person of ordinary skill in the art will appreciate, the water provides fluidity to the slurry for ease of handling, as well as provides the necessary water for hydration of the hemihydrate to gypsum. The person of ordinary skill in the art will select a desirable ratio of stucco to water. In various embodiments of the present disclosure, the weight ratio of stucco to water in the slurry is no more than 3:1, or no more than 5:2, or no more than 2:1, or no more than 7:4, or no more than 3:2. For example, in various embodiments, the weight ratio of stucco to water is in the range of 3:1 to 1:2, or 2:1 to 4:7, or 3:1 to 2:3, or 3:1 to 1:1, or 5:2 to 1:2, or 5:2 to 4:7, or 5:2 to 2:3, or 5:2 to 1:1, or 2:1 to 1:2, or 2:1 to 4:7, or 2:1 to 2:3, or 2:1 to 1:1, or 7:4 to 1:2, or 7:4 to 4:7, or 7:4 to 2:3, or 7:1 to 1:1, or 3:2 to 1:2, or 3:2 to 4:7, or 3:2 to 2:3, or 3:2 to 1:1.

Even if the board made by the methods described herein does not meet all the limitations of the boards as described above, the methods described herein can be advantaged by many of the particular parameters described above.

For example, the stucco is desirably present in the slurry to provide the set and a gypsum core with at least 75 wt % gypsum, e.g., at least 80 wt % gypsum, or at least 85 wt % gypsum.

The mixture of feed starches can be as described in any embodiment described above with respect to the gypsum boards of the disclosure. For example, in some embodiments, the method includes providing a mixture of feed starches, wherein the mixture of feed starches is a mixture of starch A, as described herein, and starch B, as described herein. In another example, in some embodiments, the method includes providing a mixture of feed starches, wherein the mixture of feed starches is a mixture of starch C, as described herein, and starch D, as described herein. In another example, in some embodiments, the method includes providing a mixture of feed starches, wherein the mixture of feed starches is a mixture of starch E, as described herein, and starch F, as described herein. But the person of ordinary skill in the art can select other combinations of starches as more broadly defined herein. The person of ordinary skill in the art can provide the mixture of feed starches in the slurry in an amount sufficient to provide a total amount of the mixture of starches in the gypsum core as described above with respect to any of the gypsum board embodiments.

While not discussed in detail here, other additives may be present in the slurry. For example, one or more accelerators, fluidizers, retarders, dispersants, foaming agents, and/or glass fibers maybe be present in the slurry.

The person of ordinary skill in the art can use conventional methods to form the slurry into a board. For example, the slurry can be dispensed between opposing liners, allowed to set, then dried.

In some embodiments, drying occurs at a temperature in the range of 50-350° C. to provide the set gypsum core. In some embodiments of the present disclosure as described herein, drying occurs at a temperature in the range of 50-325° C. or 50-300° C. (i.e., measured in the environment above the board during drying, e.g., in a drying oven). For example, in various embodiments, drying occurs at a temperature in the range of 100-350° C., or 100-325° C., or 100-300° C., or 150-350° C., or 150-325° C., or 150-300° C., or 200-350° C., or 200-325° C., or 200-300° C. Drying may be accomplished with an oven, wherein the oven temperature is in the range of 50-350° C., or 50-325° C., or 50-300° C., or 100-350° C., or 100-325° C., or 100-300° C., or 150-350° C., or 150-325° C., or 150-300° C., or 200-350° C., or 200-325° C., or 200-300° C. During the drying step, the temperature of the gypsum core does not exceed 125° C., e.g., does not exceed 120° C., 115° C., 110° C., or 105° C.

### EXAMPLES

The Examples that follow are illustrative of specific embodiments of the product and/or process of the disclosure, and various uses thereof. They are set forth for explanatory purposes only, and are not to be taken as limiting the scope of the disclosure.

### Example 1. Characterization of Mixtures of Starch A and Starch B

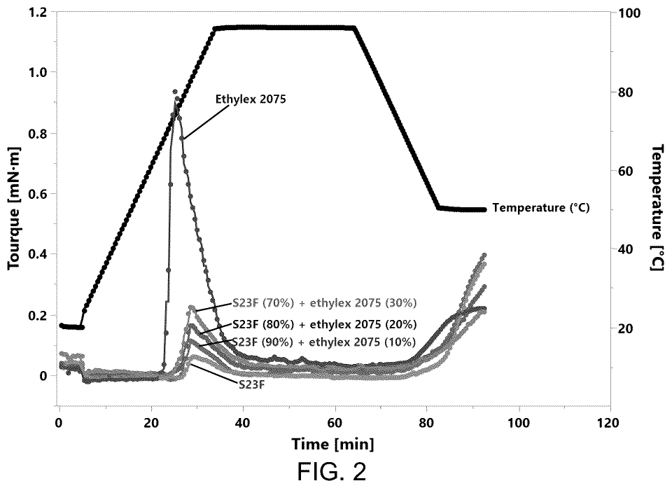

Mixtures of starches that include starch A, as described herein, and starch B, as described herein, were prepared in a variety of ratios and evaluated for their viscosity. In this example, starch A was an acid-modified corn starch (S23F, from GPC) and starch B was a hydroxyethylated dent corn starch (Ethylex 2075, from Tate & Lyle). S23F has a gel temperature of 73.6° C., a peak viscosity of 76 BU, and a hot water viscosity of 20 BU. Ethylex 2075 has a gel temperature of 62.9° C., a peak viscosity of 1156 BU, and a hot water viscosity of 67 BU. Mixtures were prepared in 90:10, 80:20, and 70:30 starch A to starch B weight ratios. These mixtures were then characterized by their peak viscosity, hot water viscosity (i.e., at the 10 minute hold time at 95 C), and gel temperature (onset temperature for initial rise in viscosity). Table 1 reports these values for the mixtures evaluated as well as for starch A and starch B individually. FIG. 2 also reports the viscoamylograms of these starches.

TABLE 1

| | | Peak | Hot Water | Gel |
|---|---|---|---|---|
| | | Viscosity | Viscosity | Temperature |
| Starch | Ratio | (BU) | (BU) | (° C.) |
| S23F | — | 76 | 20 | 73.7 |
| S23F:Ethylex 2075 | 90:10 | 92 | 20 | 72.6 |
| S23F:Ethylex 2075 | 80:20 | 127 | 20 | 69.7 |
| S23F:Ethylex 2075 | 70:30 | 182 | 27 | 67.3 |
| Ethylex 2075 | — | 1156 | 67 | 62.9 |

From Table 1 and FIG. 2, it can be seen that controlling the relative amount of starch A and starch B present in the mixture can be tuned to get a desired peak viscosity. Additionally, peak viscosity gradually increases with more Ethylex 2075 present in the mixture. Further, the gel temperature of the starch mixture can be shifted to a lower temperature by increasing the concentration of Ethylex 2075.

### Example 2. Characterization of Gypsum Board with Mixture of Starch A and Starch B

The starch mixtures of Example 1 where then evaluated for their use in gypsum boards. The mixtures were added to gypsum slurries to evaluate the slump kinetics of the prepared slurries. The test boards were made with a slurry having a water gauge of 80%, including a mixture of stucco (100 parts), accelerator (0.4 parts), fluidizer (0.4 parts), retarder (1% solution, 3.2 parts) and starch (lone starch or mixture as indicated below, 1.5 parts). The time of hydration, stiffening time, and slump were not influenced by the inclusion of the starch mixtures as compared to pure starches. As such, manufacturing changes are not required when preparing boards that include the mixture of starch A and starch B.

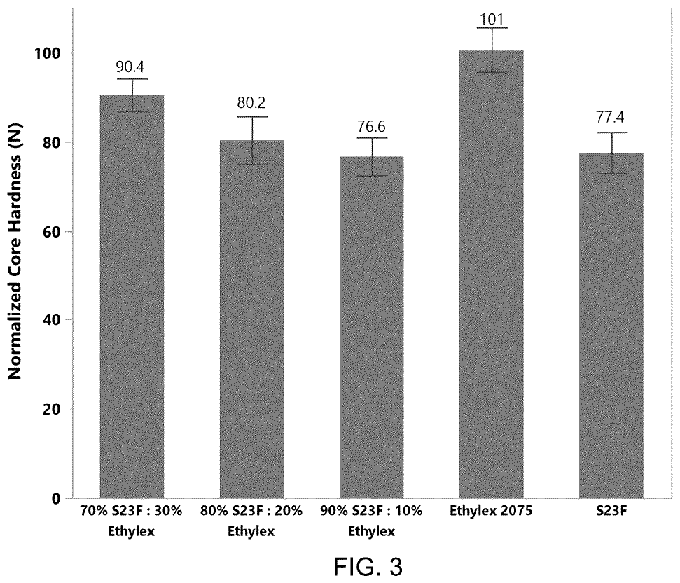

From these gypsum slurries, gypsum boards were prepared and their core hardness evaluated. These results are reported in Table 2 and FIG. 3.

TABLE 2

| Starch | Ratio | Normalized Core Hardness (N) |
|---|---|---|
| S23F | — | 77.4 |
| S23F:Ethylex 2075 | 90:10 | 76.6 |
| S23F:Ethylex 2075 | 80:20 | 80.2 |
| S23F:Ethylex 2075 | 70:30 | 90.4 |
| Ethylex 2075 | — | 101 |

From Table 2 and FIG. 3, it is observed that the core hardness increases with increased concentration of Ethylex 2075. Ethylex 2075 by itself has a 30% increased core hardness over S23F, but the inclusion of 30% Ethylex 2075 with S23F increases the overall core hardness by 17% over S23F by itself. The use of Ethylex 2075 alone is very expensive, while the mixture approach offers an increased core hardness while still being economical.

### Example 3. Characterization of Mixture of Starch C and Starch D

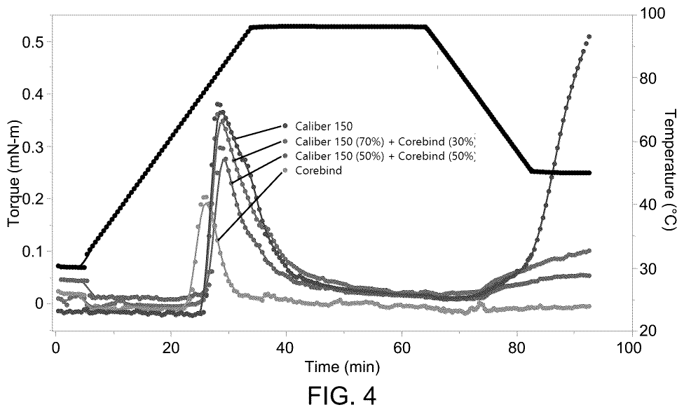

Mixtures of starches that include starch C, as described herein, and starch D, as described herein, were prepared in a variety of ratios and evaluated for their viscosity. In this example, starch C was an acid-modified corn starch (Caliber 150, from Cargill) and starch D was an acid-modified wheat starch (Corebind, from ADM). Caliber 150 has a gel temperature of 71.6° C., a peak viscosity of 447 BU, and a hot water viscosity of 33 BU. Corebind has a gel temperature of 64° C., a peak viscosity of 317 BU, and a hot water viscosity of 20 BU. Mixtures were prepared in 70:30 and 50:50 starch C to starch D weight ratios. However, the 50:50 mixture did not provide a high enough peak viscosity as desired. As such, only the 70:30 mixture was characterized by its peak viscosity, hot water viscosity (i.e., at the 10 minute hold time at 95° C.), and gel temperature (onset temperature for the inflection in rise in viscosity to the peak viscosity, as measured by the measurement provided for BU). Table 3 reports these values for the mixtures evaluated as well as for starch C and starch D individually. FIG. 4 also reports the viscoamylograms of these starches.

TABLE 4

| | | Peak | Hot Water | Gel |
|---|---|---|---|---|
| | | Viscosity | Viscosity | Temperature |
| Starch | Ratio | (BU) | (BU) | (° C.) |
| Caliber 150 | — | 447 | 33 | 71.6 |
| Caliber 150:Corebind | 70:30 | 389 | 26 | 71.6 |
| Corebind | — | 317 | 20 | 64 |

From Table 3 and FIG. 4, it can be seen that Corebind has a lower peak viscosity and a peak temperature compared to Caliber, but upon mixing, the peak viscosity and temperature shifters towards Caliber 150. However, unlike the mixture of starch A and starch B of Example 1, while the peak viscosity does lower with the addition of Corebind, the gel temperature does not change.

### Example 4. Characterization of Gypsum Board with Mixture of Starch C and Starch D

The starch mixtures of Example 3 where then evaluated for their use in gypsum boards. The mixtures were added to gypsum slurries to evaluate the slump kinetics of the prepared slurries. The time of hydration, stiffening time, and slump were not influenced by the inclusion of the starch mixtures. As such, manufacturing changes are not required when preparing boards that include the mixture of starch C and starch D.

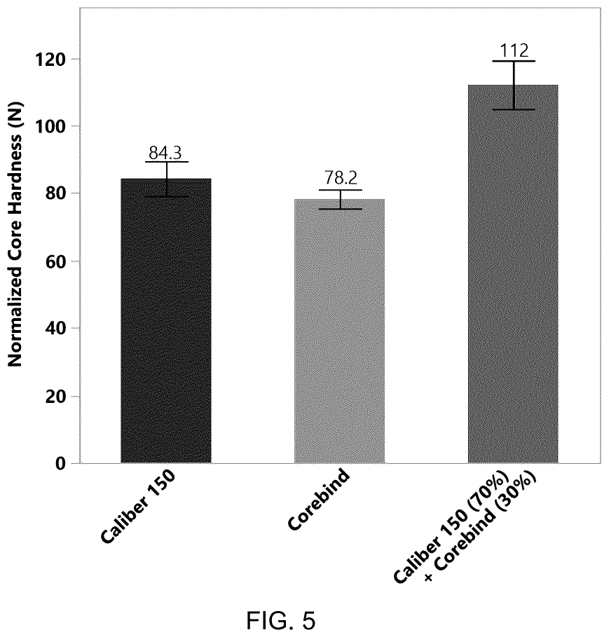

From these gypsum slurries, gypsum boards where prepared and with their hardness evaluated. These results are reported in Table 5 and FIG. 5.

TABLE 5

| Starch | Ratio | Normalized Core Hardness (N) |
|---|---|---|
| Caliber 150 | — | 84.3 |
| Caliber 150:Corebind | 70:30 | 112 |
| Caliber 150:Corebind | — | 78.2 |

From Table 5 and FIG. 5, it is observed that the core hardness of the mixture of Caliber 150 and Corebind is greater than either starch individually. Additionally, the mixture of starches showed good nail pull performance.

### Example 5. Characterization of Mixture of Starch E and Starch F

A 50:50 by weight mixture of starches that include starch E, as described herein, and starch F, as described herein, was evaluated for its viscosity and compared to the viscosities of the single starches. In this example, starch E was an acid-modified starch (LC-211, from ADM) and starch D was an acid-modified starch (LC-295, from ADM). LC-211 alone had a peak viscosity of 46 centipoise, LC-295 alone had a peak viscosity of 329 centipoise, and the 50:50 by weight mixture had a peak viscosity of 64 centipoise.

### Example 6. Characterization of Gypsum Board with Mixture of Starch E and Starch F

The starches of Example 5 where then evaluated for their use in gypsum boards. The mixtures were added to gypsum slurries to evaluate the slump kinetics of the prepared slurries. The time of hydration, stiffening time, and slump were not influenced by the inclusion of the starch mixtures. As such, manufacturing changes are not required when preparing boards that include the mixture of starch E and starch F.

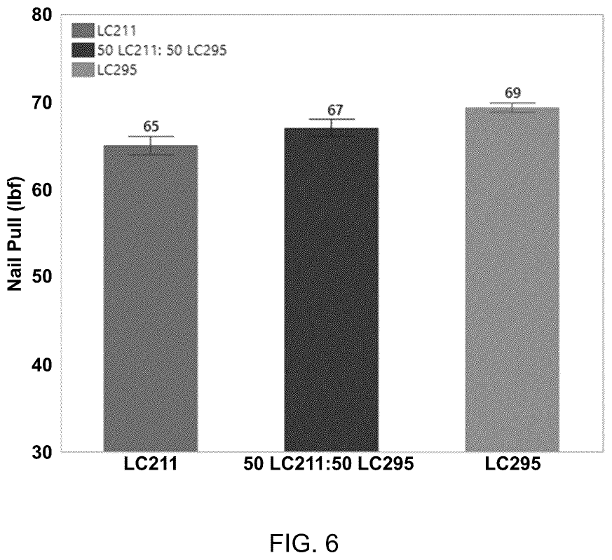

From these gypsum slurries, gypsum boards were prepared and evaluated for nail pull resistance according to ASTM C473 method B. These results are reported in FIG. 6.

Various aspects and embodiments of the disclosure are provided by the following enumerated embodiments, which may be combined in any number and in any combination that is not technically or logically inconsistent.
Embodiment 1. A gypsum board comprising a gypsum core, wherein the set gypsum core comprises:
   a set body of calcium sulfate dihydrate; and
   a mixture of starches;
wherein the set gypsum core is made by the method comprising:
   providing a slurry comprising stucco, water, and a mixture of feed starches, the mixture having a peak viscosity in the range of 50 to 600 BU, the mixture of feed starches being present in an amount in the range of 0.05 wt % to 3 wt % of the weight of the stucco, based on the gypsum core of the gypsum board;
   allowing the slurry to set to form a wet gypsum core; and
   drying the wet gypsum core at a temperature in the range of 50-350° C. to provide a set gypsum core,
   wherein the mixture of feed starches comprises a first starch and a second starch, the first starch having a substantially lower peak viscosity than the second starch.
Embodiment 2. The gypsum board of Embodiment 1, wherein the first starch has a peak viscosity of at least 50 BU less than and/or at least 50 centipoise less than the peak viscosity of the second starch.
Embodiment 3. The gypsum board of Embodiment 1, wherein the first starch has a peak viscosity of at least 75 BU less than and/or at least 75 centipoise less than the peak viscosity of the second starch.
Embodiment 4. The gypsum board of Embodiment 1, wherein the first starch has a peak viscosity of at least 100 BU less than and/or at least 100 centipoise less than the peak viscosity of the second starch.
Embodiment 5. The gypsum board of Embodiment 1, wherein the first starch has a peak viscosity of at least 120 BU less than and/or at least 120 centipoise less than the peak viscosity of the second starch.
Embodiment 6. The gypsum board of Embodiment 1, wherein the first starch has a peak viscosity of at least 150 BU less than and/or at least 150 centipoise less than the peak viscosity of the second starch.
Embodiment 7. The gypsum board of Embodiment 1, wherein the first starch has a peak viscosity of at least 200 BU less than and/or at least 200 centipoise less than the peak viscosity of the second starch.
Embodiment 8. The gypsum board of Embodiment 1, wherein the first starch has a peak viscosity of at least 350 BU less than and/or at least 350 centipoise less than the peak viscosity of the second starch.
Embodiment 9. The gypsum board of Embodiment 1, wherein the first starch has a peak viscosity of at least 500 BU less than and/or at least 500 centipoise less than the peak viscosity of the second starch.
Embodiment 10. The gypsum board of any of Embodiments 1-9, wherein the mixture of the feed starches has a peak viscosity in the range of 50-600 BU, e.g., 50-550 BU, or 50-500 BU, or 50-450 BU, or 50-400 BU.
Embodiment 11. The gypsum board any of Embodiments 1-9, wherein the mixture of the feed starches has a peak viscosity in the range of 100-600 BU, e.g., 100-550 BU, or 100-500 BU, or 100-450 BU, or 100-400 BU.
Embodiment 12. The gypsum board any of Embodiments 1-9, wherein the mixture of the feed starches has a peak viscosity in the range of 150-600 BU, e.g., 150-550 BU, or 150-500 BU, or 150-450 BU, or 150-400 BU.
Embodiment 13. The gypsum board any of Embodiments 1-9, wherein the mixture of the feed starches has a peak viscosity in the range of 50-600 centipoise, e.g., 50-550 centipoise, or 50-500 centipoise, or 50-450 centipoise, or 50-400 centipoise.
Embodiment 14. The gypsum board any of Embodiments 1-9, wherein the mixture of the feed starches has a peak viscosity in the range of 100-600 centipoise, e.g., 100-550 centipoise, or 100-500 centipoise, or 100-450 centipoise, or 100-400 centipoise.
Embodiment 15. The gypsum board any of Embodiments 1-9, wherein the mixture of the feed starches has a peak viscosity in the range of 150-600 centipoise, e.g., 150-550 centipoise, or 150-500 centipoise, or 150-450 centipoise, or 150-400 centipoise.
Embodiment 16. The gypsum board of any of Embodiments 1-15, wherein the first starch has a gel temperature at least 5° C. higher than a gel temperature of the second starch, e.g., at least 7° C. higher, or at least 10° C. higher.
Embodiment 17. The gypsum board of any of Embodiments 1-15, wherein the first starch has a gel temperature in the range of 5-20° C. higher than a gel temperature of the second starch, e.g., in the range of 7-20° C. higher, or 10-20° C. higher, or 5-17° C. higher, or 7-17° C. higher, or 10-17° C. higher, or 5-15° C. higher, or 7-15° C. higher, or 10-15° C. higher, or 5-12° C. higher, or 7-12° C. higher, or 5-10° C. higher.
Embodiment 18. The gypsum board of any of Embodiments 1-17, wherein the mixture of feed starches have a gel temperature of no more than 100° C. (e.g., no more than 95° C., or 90° C., or no more than 85° C., or no more than 80° C., or no more than 75° C., or no more than 72° C.).
Embodiment 19. The gypsum board of any of Embodiments 1-17, wherein the mixture of feed starches have a gel temperature in the range of 60-100° C. (e.g., in the range of 60-95° C., or 60-90° C., or 60-85° C., or 60-80° C., or 60-75° C., or 60-72° C., or 65-100° C., or 65-95° C., or 60-90° C., or 60-85° C., or 65-80° C., or 65-75° C., or 65-72° C.).
Embodiment 20. The gypsum board of any of Embodiments 1-19, wherein the first starch is an acid-modified starch.
Embodiment 21. The gypsum board of any of Embodiments 1-20, wherein the first starch is not crosslinked and is not modified by substitution.
Embodiment 22. The gypsum board of any of Embodiments 1-21, wherein the second starch is an acid-modified starch.
Embodiment 23. The gypsum board of any of Embodiments 1-21, wherein the second starch is not an acid-modified starch.
Embodiment 24. The gypsum board of any of Embodiments 1-23, wherein the second starch is modified by substitution, e.g., by hydroxyalkylation (e.g., hydroxyethylation, hydroxypropylation, hydroxybutylation); acylation (e.g., acetylation); carboxymethylation; alkylation (e.g., ethylation, butylation, or propylation); or succination.
Embodiment 25. The gypsum board of any of Embodiments 1-24, wherein a weight ratio of the first starch to the second starch is in the range of 10:90-90:10, e.g., 10:90-50:50, or 10:90-30:70, or 50:50-90:10, or 70:30-90:10.
Embodiment 26. The gypsum board of any of Embodiments 1-24, wherein a weight ratio of the first starch to the second starch is in the range of 20:80-80:20, e.g., 20:80-50:50, or 20:80-40:60, or 50:50-80:20, or 60:40-80:20.
Embodiment 27. The gypsum board of any of Embodiments 1-24, wherein a weight ratio of the first starch to the second starch is in the range of 30:70-70:30, e.g., 30:70-50:50, or 50:50-30:70.
Embodiment 28. The gypsum board of any of Embodiments 1-24, wherein a weight ratio of the first starch to the second starch is in the range of 40:60-60:40.
Embodiment 29. The gypsum board of any of Embodiments 1-28, wherein the mixture of feed starches is a combination of starch A and starch B, wherein starch A is an acid-modified starch having a peak viscosity of no more than 200 BU and starch B is a chemically-modified starch having a peak viscosity of at least 800 BU.
Embodiment 30. The gypsum board of Embodiment 29, wherein starch A has a peak viscosity of no more than 175 BU (e.g., no more than 150 BU, or no more than 125 BU, or no more than 100 BU, or no more than 75 BU).
Embodiment 31. The gypsum board of Embodiment 29 or Embodiment 30, wherein starch A has a peak viscosity in the range of 30-200 BU (e.g., in the range or 30-175 BU, or 30-150 BU, or 30-125 BU, or 30-100 BU, or 60-200 BU, or 60-175 BU, or 60-150 BU, or 60-125 BU, or 60-100 BU).
Embodiment 32. The gypsum board of any of Embodiments 29-31, wherein starch A is acid-modified but is otherwise unmodified.
Embodiment 33. The gypsum board of any of Embodiments 29-32, wherein starch A is not inhibited.
Embodiment 34. The gypsum board of any of Embodiments 29-33, wherein starch A is a corn starch, a wheat starch, a tapioca starch, a potato starch, a pea starch, a sorghum starch, or a rice starch.
Embodiment 35. The gypsum board of any of Embodiments 29-33, wherein starch A is a corn starch.
Embodiment 36. The gypsum board of any of Embodiments 29-35, wherein starch A is a dent corn starch.
Embodiment 37. The gypsum board of any of Embodiments 29-36, wherein starch A is not pregelatinized.
Embodiment 38. The gypsum board of any of Embodiments 29-37, wherein starch A has a gel temperature of no more than 100° C. (e.g., no more than 95° C., or no more than 90° C., or no more than 85° C., or no more than 80° C., or no more than 75° C.).
Embodiment 39. The gypsum board of any of Embodiments 29-39, wherein starch A has a gel temperature in the range of 60-90° C. (e.g., in the range of 60-85° C., or 60-80° C., or 60-75° C., or 60-90° C., or 60-85° C., or 65-80° C., or 65-75° C.).
Embodiment 40. The gypsum board of any of Embodiments 29-39, wherein starch B has a peak viscosity of at least 900 BU (e.g., at least 950 BU, or at least 1000 BU, or at least 1050 BU, or at least 1100 BU, or at least 1150 BU).
Embodiment 41. The gypsum board of any of Embodiments 29-40, wherein starch B has a peak viscosity in the range of 800-1400 BU (e.g., in the range of 800-1300 BU, or 800-1200 BU, or 900-1400 BU, or 900-1300-BU, or 900-1200 BU, or 1000-1400 BU, or 1000-1300 BU, or 1000-1200 BU).
Embodiment 42. The gypsum board of any of Embodiments 29-41, wherein the modification of starch B is a hydroxyalkylation (e.g., hydroxyethylation, hydroxypropylation, hydroxybutylation).
Embodiment 43. The gypsum board of any of Embodiments 29-42, wherein the modification of starch B is a hydroxyethylation.
Embodiment 44. The gypsum board of any of Embodiments 29-43, wherein starch B is hydroxyalkylated (e.g., hydroxyethylated) but is otherwise unmodified.
Embodiment 45. The gypsum board of any of Embodiments 29-44, wherein starch B is not inhibited.
Embodiment 46. The gypsum board of any of Embodiments 29-45, wherein starch B is a corn starch, a wheat starch, a tapioca starch, a potato starch, a pea starch, a sorghum starch or a rice starch.
Embodiment 47. The gypsum board of any of Embodiments 29-47 (e.g., of
Embodiment 35), wherein starch B is a corn starch, e.g., a dent corn starch.
Embodiment 48. The gypsum board of any of Embodiments 29-47, wherein starch B is a dent corn starch.
Embodiment 49. The gypsum board of any of Embodiments 29-48, wherein starch B is not pregelatinized.
Embodiment 50. The gypsum board of any of Embodiments 29-49, wherein starch B has a gel temperature of no more than 100° C. (e.g., no more than 95° C., or no more than 90° C., or no more than 85° C., or no more than 80° C., or no more than 75° C., or no more than 70° C., or no more than 65° C.).
Embodiment 51. The gypsum board of any of Embodiments 29-50, wherein starch B has a gel temperature in the range of 50-80° C. (e.g., in the range of 50-75° C., or 50-70° C., or 50-65° C., or 55-80° C., or 55-75° C., or 55-70° C., or 55-65° C.).
Embodiment 52. The gypsum board of any of Embodiments 29-51, wherein the gel temperature of starch A is greater than the gel temperature of starch B.
Embodiment 53. The gypsum board of any of Embodiments 29-52, wherein the weight ratio of starch A to starch B in the mixture of feed starches is no more than 90:10.
Embodiment 54. The gypsum board of any of Embodiments 29-52, wherein the weight ratio of starch A to starch B in the mixture of feed starches is no more than 85:15 (e.g., no more than 80:20, or 75:25, or 70:30).
Embodiment 55. The gypsum board of any of Embodiments 29-52, wherein the weight ratio of starch A to starch B is in the mixture of feed starches is in the range of 50:50 to 90:10 (e.g., in the range of 50:50 to 80:20, or 50:50 to 70:30, or 60:40 to 90:10, or 60:40 to 80:20, or 60:40 to 70:30).
Embodiment 56. The gypsum board of any of Embodiments 1-28, wherein the mixture of feed starches is a mixture of starch C and starch D, wherein starch C is an acid-modified starch having a peak viscosity of at least 385 BU and starch D is an acid-modified starch having a peak viscosity of no more than 375 BU.
Embodiment 57. The gypsum board of Embodiment 56, wherein starch C has a peak viscosity of at least 400 BU (e.g., at least 425 BU).
Embodiment 58. The gypsum board of Embodiment 56 or Embodiment 57, wherein starch C has a peak viscosity in the range of 385-800 BU (e.g., in the range of 385-700 BU, or 385-600 BU, or 385-500 BU, or 400-800 BU, or 400-700 BU, or 400-600 BU, or 400-500 BU, or 425-800 BU, or 425-700 BU, or 425-600 BU, or 425-500 BU).
Embodiment 59. The gypsum board of any of Embodiments 56-58, wherein starch C is acid-modified but is otherwise unmodified.
Embodiment 60. The gypsum board of any of Embodiments 56-59, wherein starch C is not inhibited.
Embodiment 61. The gypsum board of any of Embodiments 56-60, wherein starch C is a corn starch, a wheat starch, a tapioca starch, a potato starch, a pea starch, a sorghum starch or a rice starch.
Embodiment 62. The gypsum board of any of Embodiments 56-60, wherein starch C is a corn starch.
Embodiment 63. The gypsum board of any of Embodiments 56-62, wherein starch C is a dent corn starch.
Embodiment 64. The gypsum board of any of Embodiments 56-63, wherein starch C is not pregelatinized.
Embodiment 65. The gypsum board of any of Embodiments 56-64, wherein starch C has gel temperature has a gel temperature of no more than 100° C. (e.g., no more than 95° C., or no more than 90° C., or no more than 85° C., or no more than 80° C., or no more than 75° C.).
Embodiment 66. The gypsum board of any of Embodiments 56-64, wherein starch C has a gel temperature in the range of 60-90° C. (e.g., in the range of 60-85° C., or 60-80° C., or 60-75° C., or 60-90° C., or 60-85° C., or 65-80° C., or 65-75° C.).
Embodiment 67. The gypsum board of any of Embodiments 56-66, wherein starch D has a peak viscosity of no more than 350 BU.
Embodiment 68. The gypsum board of any of Embodiments 56-67, wherein starch D has a peak viscosity in the range of 150-375 BU (e.g., in the range of 200-375 BU, or 250-375 BU, or 300-375 BU, or 150-350 BU, or 200-350 BU, or 250-350 BU, or 300-350 BU).
Embodiment 69. The gypsum board of any of Embodiments 56-68, wherein the gel temperature of starch C is greater than the gel temperature of starch D.
Embodiment 70. The gypsum board of any of Embodiments 56-69, wherein starch D is a corn starch, a wheat starch, a tapioca starch, a potato starch, a pea starch, a sorghum starch or a rice starch.
Embodiment 71. The gypsum board of any of Embodiments 56-69 (e.g., of
Embodiment 62), wherein starch D is a wheat starch.
Embodiment 72. The gypsum board of any of Embodiments 56-71, wherein starch D is a dent corn starch.
Embodiment 73. The gypsum board of any of Embodiments 56-72, wherein starch D is derived from a different crop source than a crop source of starch C.
Embodiment 74. The gypsum board of any of Embodiments 56-72, wherein starch D is a wheat starch and starch C is a corn starch.
Embodiment 75. The gypsum board of any of Embodiments 56-74, wherein starch D is not pregelatinized.
Embodiment 76. The gypsum board of any of Embodiments 56-75, wherein starch D has a gel temperature of no more than 100° C. (e.g., no more than no more than 95° C., or no more than 90° C., or no more than 85° C., or no more than 80° C., or no more than 75° C., or no more than 70° C., or no more than 65° C.).
Embodiment 77. The gypsum board of any of Embodiments 56-76, wherein starch D has a gel temperature in the range of 50-80° C. (e.g., in the range of 50-75° C., or 50-70° C., or 50-65° C., or 55-80° C., or 55-75° C., or 55-70° C., or 55-65° C.).
Embodiment 78. The gypsum board of any of Embodiments 56-77, wherein a weight ratio of starch C to starch D in the mixture of feed starches is no more than 90:10.
Embodiment 79. The gypsum board of any of Embodiments 56-77, wherein a weight ratio of starch C to starch D in the mixture of feed starches is no more than 85:15 (e.g., no more than 80:20, or 75:25, or 70:30).
Embodiment 80. The gypsum board of any of Embodiments 56-77, wherein a weight ratio of starch C to starch D in the mixture of feed starches is in the range of 50:50 to 90:10 (e.g., in the range of 50:50 to 80:20, or 50:50 to 70:30, or 60:40 to 90:10, or 60:40 to 80:20, or 60:40 to 70:30).
Embodiment 81. The gypsum board of any of Embodiments 1-28, wherein the mixture of starches is a combination of starch E and starch F, wherein starch F is an acid-modified starch having a peak viscosity of no more than 100 centipoise and starch F is an acid-modified starch having a peak viscosity at least 200 centipoise.
Embodiment 82. The gypsum board of Embodiment 81, wherein starch C has a peak viscosity of no more than 80 centipoise, e.g., no more than 60 centipoise.
Embodiment 83. The gypsum board of Embodiment 81 or Embodiment 82, wherein starch E has a peak viscosity in the range of 20-100 centipoise (e.g., in the range of 30-100 centipoise, or 35-100 centipoise, or 40-100 centipoise, or 20-80 centipoise, or 30-80 centipoise, or 35-80 centipoise, or 40-80 centipoise, or 20-60 centipoise, or 30-60 centipoise, or 35-60 centipoise, or 40-60 centipoise).
Embodiment 84. The gypsum board of any of Embodiments 81-83, wherein starch E is acid-modified but is otherwise unmodified.
Embodiment 85. The gypsum board of any of Embodiments 81-83, wherein starch E is not inhibited.
Embodiment 86. The gypsum board of any of Embodiments 81-85, wherein starch E is a corn starch, a wheat starch, a tapioca starch, a potato starch, a pea starch, a sorghum starch or a rice starch.
Embodiment 87. The gypsum board of any of Embodiments 81-85, wherein starch E is a sorghum starch.
Embodiment 88. The gypsum board of any of Embodiments 81-87, wherein starch E is not pregelatinized.
Embodiment 89. The gypsum board of any of Embodiments 81-88, wherein starch E has gel temperature has a gel temperature of no more than 100° C. (e.g., no more than 95° C., or no more than 90° C., or no more than 85° C., or no more than 80° C., or no more than 75° C.).
Embodiment 90. The gypsum board of any of Embodiments 81-88, wherein starch E has a gel temperature in the range of 60-90° C. (e.g., in the range of 60-85° C., or 60-80° C., or 60-75° C., or 60-90° C., or 60-85° C., or 65-80° C., or 65-75° C.).
Embodiment 91. The gypsum board of any of Embodiments 81-90, wherein starch F has a peak viscosity of at least 250 centipoise, e.g., at least 300 centipoise.
Embodiment 92. The gypsum board of any of Embodiments 81-90, wherein starch F has a peak viscosity in the range of 200-600 centipoise, e.g., in the range of 200-500 centipoise, or 200-400 centipoise, or 250-600 centipoise, or 250-500 centipoise, or 250-400 centipoise, or 300-600 centipoise, or 300-500 centipoise, or 300-400 centipoise.
Embodiment 93. The gypsum board of any of Embodiments 81-92, wherein the gel temperature of starch E is greater than the gel temperature of starch F.
Embodiment 94. The gypsum board of any of Embodiments 81-93, wherein starch F is a corn starch, a wheat starch, a tapioca starch, a potato starch, a pea starch, a sorghum starch or a rice starch.
Embodiment 95. The gypsum board of any of Embodiments 81-93 (e.g., of
Embodiment 87), wherein starch F is a sorghum starch.
Embodiment 96. The gypsum board of any of Embodiments 81-95, wherein starch F is not pregelatinized.
Embodiment 97. The gypsum board of any of Embodiments 81-96, wherein starch D has a gel temperature of no more than 100° C. (e.g., no more than 95° C., or no more than 90° C., or no more than 85° C., or no more than 80° C., or no more than 75° C., or no more than 70° C., or no more than 65° C.).
Embodiment 98. The gypsum board of any of Embodiments 81-96, wherein starch D has a gel temperature in the range of 50-80° C. (e.g., in the range of 50-75° C., or 50-70° C., or 50-65° C., or 55-80° C., or 55-75° C., or 55-70° C., or 55-65° C.).
Embodiment 99. The gypsum board of any of Embodiments 81-98, wherein a weight ratio of starch E to starch F in the mixture of feed starches is no more than 90:10.
Embodiment 100. The gypsum board of any of Embodiments 81-98, wherein a weight ratio of starch E to starch F in the mixture of feed starches is no more than 85:15 (e.g., no more than 80:20, or 75:25, or 70:30).
Embodiment 101. The gypsum board of any of Embodiments 81-98, wherein a weight ratio of starch E to starch F in the mixture of feed starches is in the range of 10:90-90:10, e.g., 20:80-80:20.
Embodiment 102. The gypsum board of any of embodiments 81-98, wherein a weight ratio of starch E to starch F in the mixture of feed starches is in the range of 30:70-70:30, e.g., in the range of 30:70-60:40, or 30:70-50:50, or 40:60-70:30, or 40:60-60:40, or 50:50-70:30.
Embodiment 103. The gypsum board of any of Embodiments 1-102, wherein the mixture of feed starches is uncooked when provided to the slurry.
Embodiment 104. The gypsum board of any of Embodiments 1-103, wherein the mixture of starches is present in an amount in the range of 0.05-2.5 wt %, or 0.05-2 wt %, or 0.05-1.5 wt % of the stucco used to make the slurry used to make the gypsum core.
Embodiment 105. The gypsum board of any of Embodiments 1-103, wherein the mixture of starches is present in an amount in the range of 0.1-3 wt %, e.g., 0.1-2.5 wt %, or 0.1-2 wt %, or 0.1-1.5 wt % of the stucco used to make the slurry used to make the gypsum core.
Embodiment 106. The gypsum board of any of Embodiments 1-103, wherein the mixture of starches is present in an amount in the range of 0.5-3 wt %, e.g., 0.5-2.5 wt %, or 0.5-2 wt %, or 0.5-1.5 wt % of the stucco used to make the slurry used to make the gypsum core.
Embodiment 107. The gypsum board of any of Embodiments 1-103, wherein the mixture of starches is present in an amount in the range of 0.75-3 wt %, e.g., 0.75-2.5 wt %, or 0.75-2 wt %, or 0.75-1.5 wt % of the stucco used to make the slurry used to make the gypsum core.
Embodiment 108. The gypsum board of any of Embodiments 1-103, wherein the mixture of starches is present in an amount in the range of 1-3 wt %, e.g., 1-2.5 wt %, or 1-2 wt %, or 1-1.5 wt % of the stucco used to make the slurry used to make the gypsum core.
Embodiment 109. The gypsum board of any of Embodiments 1-108 having a normalized core hardness of at least 60 N (e.g., at least 65 N, or at least 70 N, or at least 75 N).
Embodiment 110. The gypsum board of any of Embodiments 1-109, wherein the gypsum core is disposed between a first liner at a first major surface of the gypsum board and a second liner at a second, opposing major surface of the board.
Embodiment 111. The gypsum board of Embodiment 110, wherein the liners are paper liners.
Embodiment 112. A method of forming a gypsum board comprising a gypsum core (e.g., a board of any of Embodiments 1-111), the method comprising:
   providing a slurry comprising stucco, water, and the mixture of feed starches having a peak viscosity in the range of 50 to 600 BU, the mixture of feed starches being present in an amount in the range of 0.05-3 wt % of the stucco,
   wherein the mixture of feed starches, the slurry and/or the gypsum board is as described above in any combination of one or more Embodiments 1-110.
Embodiment 113. The method of Embodiment 112, wherein the weight ratio of stucco to water is no more than 2:1 (e.g., no more than 7:4, or no more than 3:2).
Embodiment 114. The method of Embodiment 112, wherein the weight ratio of stucco to water is in the range of 2:1 to 1:2 (e.g., in the range of 2:1 to 4:7, or 2:1 to 2:3, or 2:1 to 1:1, or 7:4 to 1:2, or 7:4 to 4:7, or 7:4 to 2:3, or 7:1 to 1:1, or 3:2 to 1:2, or 3:2 to 4:7, or 3:2 to 2:3, or 3:2 to 1:1).
Embodiment 115. The method of any of Embodiments 112-114, wherein stucco is present in the slurry to provide the set and dried gypsum core with at least 75 wt % gypsum, e.g., at least 80 wt % gypsum or at least 85 wt % gypsum.
Embodiment 116. The method of any of Embodiments 112-114, wherein the mixture of starches, the slurry, and/or the gypsum board is as described in any combination of one or more of Embodiments 2-28 and 103-111.
Embodiment 117. The method of any of Embodiments 112-114, wherein the mixture of starches, the slurry, and/or the gypsum board is as described in any of Embodiments 29-55 and 103-111.
Embodiment 118. The method of any of Embodiments 112-114, wherein the amount of the mixture of starches, the slurry, and/or the gypsum board is as described in any of Embodiments 56-80 and 103-111.
Embodiment 119. The method of any of Embodiments 112-114, wherein the amount of the mixture of starches, the slurry, and/or the gypsum board is as described in any of Embodiments 81-111.
Embodiment 120. The method of forming a gypsum board of any of Embodiments 112-119, wherein the drying occurs at a temperature in the range of 50-325° C. (e.g., in the range of 50-300° C.).
Embodiment 121. The method of forming a gypsum board of any of Embodiments 112-119, wherein the drying occurs at a temperature in the range of 100-350° C. (e.g., in the range of 100-325° C., or 100-300° C.).
Embodiment 122. The method of forming a gypsum board of any of Embodiments 112-119, wherein the drying occurs at a temperature in the range of 150-350° C. (e.g., in the range of 150-325° C., or 150-300° C.).
Embodiment 123. The method of forming a gypsum board of any of Embodiments 112-119, wherein the drying occurs at a temperature in the range of 200-350° C. (e.g., in the range of 200-325° C., or 200-300° C.).

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice. Thus, before the disclosed processes and devices are described, it is to be understood that the aspects described herein are not limited to specific embodiments, apparatuses, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. It will be further understood that the endpoints of each of the ranges are significant both in relation to the other endpoint, and independently of the other endpoint.

All methods described herein can be performed in any suitable order of steps unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

Unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, it is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

We claim:

1. A gypsum board comprising a set gypsum core, wherein the set gypsum core comprises:
a set body of calcium sulfate dihydrate; and
a mixture of starches;
wherein the set gypsum core is made by the method comprising:
providing a slurry comprising stucco, water, and a mixture of feed starches, the mixture having a peak viscosity in the range of 50 to 600 BU and/or in the range of 50-600 centipoise, the mixture of feed starches being present in an amount in the range of 0.05 wt % to 3 wt % of the weight of the stucco, based on the gypsum core of the gypsum board;
allowing the slurry to set to form a wet gypsum core; and
drying the wet gypsum core at a temperature in the range of 50-350° C. to provide a set gypsum core,
wherein the mixture of feed starches comprises a first starch and a second starch, the first starch having a substantially lower peak viscosity than the second starch.

2. The gypsum board of claim 1, wherein the first starch has a peak viscosity of at least 100 BU less than and/or at least 100 centipoise less than the peak viscosity of the second starch.

3. The gypsum board of claim 1, wherein a weight ratio of the first starch to the second starch is in the range of 20:80-80:20, e.g., 20:80-50:50, or 50:50-20:80.

4. The gypsum board of claim 1, wherein the mixture of feed starches is a mixture of starch A and starch B, wherein starch A is an acid-modified starch having a peak viscosity of no more than 200 BU and starch B is a chemically-modified starch having a peak viscosity of at least 800 BU.

5. The gypsum board of claim 4, wherein starch A has a peak viscosity in the range of 30-200 BU, and is acid-modified but is otherwise unmodified.

6. The gypsum board of claim 4, wherein starch B has a peak viscosity in the range of 800-1400 BU, and is hydroxyethylated but is otherwise unmodified.

7. The gypsum board of claim 4, wherein the gel temperature of starch A is greater than the gel temperature of starch B.

8. The gypsum board of claim 1, wherein the mixture of feed starches is a mixture of starch C and starch D, wherein starch C is an acid-modified starch having a peak viscosity of at least 385 BU and starch D is an acid-modified starch having a peak viscosity of no more than 375 BU.

9. The gypsum board of claim 8, wherein starch C has a peak viscosity in the range of 385-800 BU, and is acid-modified but is otherwise unmodified.

10. The gypsum board of claim 8, wherein starch D has a peak viscosity in the range of 150-375 BU.

11. The gypsum board of claim 8, wherein the gel temperature of starch C is greater than the gel temperature of starch D.

12. The gypsum board of claim 8, wherein starch C is a dent corn starch and starch D is a wheat starch.

13. The gypsum board of claim 1, wherein the mixture of starches is a combination of starch E and starch F, wherein starch F is an acid-modified starch having a peak viscosity of no more than 100 centipoise and starch F is an acid-modified starch having a peak viscosity at least 200 centipoise.

14. The gypsum board of claim 1, wherein the mixture of starches is present in an amount in the range of 0.75-3 wt % of the stucco used to make the slurry used to make the gypsum core.

15. A method of forming a gypsum board comprising a gypsum core, the method comprising:
providing a slurry comprising stucco, water, and the mixture of feed starches having a peak viscosity in the range of 50 to 600 BU, the mixture of feed starches being present in an amount in the range of 0.05-3 wt % of the stucco;
allowing the slurry to set to form a wet gypsum core; and
drying the wet gypsum core at a temperature in the range of 50-350° C. to provide a set gypsum core,
wherein the mixture of feed starches comprises a first starch and a second starch, the first starch having a substantially lower peak viscosity than the second starch.

16. The method of claim 15, wherein the first starch has a peak viscosity of at least 100 BU less than and/or at least 100 centipoise less than the peak viscosity of the second starch.

17. The method of claim 15, wherein the mixture of feed starches is a mixture of starch A and starch B, wherein starch A is an acid-modified starch having a peak viscosity of no more than 200 BU and starch B is a chemically-modified starch having a peak viscosity of at least 800 BU.

18. The method of claim 15, wherein the mixture of feed starches is a mixture of starch C and starch D, wherein starch C is an acid-modified starch having a peak viscosity of at least 385 BU and starch D is an acid-modified starch having a peak viscosity of no more than 375 BU.

19. The method of claim 15, wherein the mixture of starches is a combination of starch E and starch F, wherein starch F is an acid-modified starch having a peak viscosity of no more than 100 centipoise and starch F is an acid-modified starch having a peak viscosity at least 200 centipoise.

20. The method of claim 15, wherein the mixture of starches is present in an amount in the range of 0.75-3 wt % of the stucco used to make the slurry used to make the gypsum core.
